(19) United States
(12) Patent Application Publication
(10) Pub. No.: US 2020/0153842 A1
(43) Pub. Date: May 14, 2020

(54) SYSTEM AND METHOD FOR PREVENTING A STEGOSPLOIT ATTACK

(71) Applicant: SRM INSTITUTE OF SCIENCE AND TECHNOLOGY, Kancheepuram (IN)

(72) Inventors: JEYASEKAR ANTHONY, Kancheepuram (IN); ARPAN ABANI SARKAR, Kancheepuram (IN); TANIMA SARBAJNA, Kancheepuram (IN)

(21) Appl. No.: 16/680,498

(22) Filed: Nov. 12, 2019

(30) Foreign Application Priority Data
Nov. 9, 2018 (IN) 201841042265

(51) Int. Cl. H04L 29/06

(52) U.S. Cl. CPC H04L 63/145

(57) ABSTRACT

A system including a stegosploit attack prevention engine (SAPE) and a method for proactively preventing a stegosploit attack are provided. The SAPE extracts multiple images from an image rendering component, for example, a webpage, received from a web server, prior to loading of the images on a computing device. Any one or more of the images is a compromised image including an exploit code and a decoder code embedded in the pixels of the compromised image. The SAPE generates a replacement image for the compromised image by manipulating pixels of the compromised image. The SAPE manipulates the pixels of the compromised image by filtering, compressing, and encoding the compromised image, thereby deactivating the exploit code and the decoder code of the compromised image. The SAPE embeds the replacement image in place of the compromised image in the image rendering component and delivers the replacement image to the computing device.

### CROSS-REFERENCE TO RELATED APPLICATIONS

This application claims priority to and the benefit of the provisional patent application titled “A SYSTEM AND METHOD FOR PREVENTING STEGOSPLOIT ATTACK”, application number 201841042265, filed in the Indian Patent Office on Nov. 9, 2018. The specification of the above referenced patent application is incorporated herein by reference in its entirety.

### BACKGROUND

### Technical Field

The embodiments herein, in general, relate to protection of a computing device. More particularly, the embodiments herein relate to a system and a method for preventing a stegosploit attack at a computing device, for example, a client device, by manipulating pixels in compromised images.

### Description of the Related Art

Web security involves securing a website or a web application by detecting, preventing, and responding to cyberattacks or attempts by attackers or hackers to exploit, damage, or destroy a computing device, for example, a client device, that accesses the website or the web application. As advancements in computing technology are increasing, web hacking activities have increased where attackers develop different, advanced hacking techniques to attack computing devices and gain an unauthorized access to the computing devices. One of these hacking techniques includes an exploit delivery technique that delivers a malicious code, herein referred to as an “exploit code”, to a client device to damage a computing environment of the client device. The exploit code is a software code or a sequence of commands that operates on or exploits a bug or a vulnerability in the client device. There are multiple methods for delivering the exploit code to a web browser. An attacker may send the exploit code directly to a user through an electronic mail (email) spam or attempt to trick the user into clicking a uniform resource locator (URL) link of an exploit delivery server from where an attack is executed. Some attackers use spyware to exploit an application on the client device of a target user and spy on the target user by sending an exploit link to the target user through the application. If the target user clicks on the exploit link, the spyware or malware or exploit code, that allows surveillance of the client device or provides a complete access control of the client device to the attackers, is installed on the client device. Some attackers use compromised websites that act as contact paths through which deceptive URL links are delivered to the user's client device. When the user clicks on a deceptive URL link on a webpage of a compromised website, the attacker injects an exploit code that redirects the user to an exploit kit where the attacker identifies intended victims, for example, visitors, from a specific country. The exploit kit is an automated, utility, threat program that utilizes compromised websites to divert web traffic, identify vulnerable browser-based applications, and run malware. The exploit kit automatically and silently exploits vulnerabilities on client devices while a user browses the web. The exploit kit discretely diverts web traffic from a webpage of a compromised website to another landing webpage. The landing webpage comprises an exploit code that profiles the user's client device for vulnerable browser-based applications and runs malware on the client device.

Steganography is a technique for hiding secret information in an image by manipulating pixels of an image. The secret information is converted into a bit stream and encoded in one of the bits, for example, a least significant bit (LSB), of the image. The secret information hidden in the image is capable of being decoded by a decoder or a decoder code. A user who views the steganographic image does not suspect that the steganographic image has secret information, as the secret information is encoded in the LSB of the image which has negligible impact on the quality of the original image. Similar to hiding secret information in an image, attackers use steganography as an exploit delivery technique for delivering an exploit code to a client device to harm the computing environment of the client device. The attackers embed an exploit code and a decoder code, bit by bit, in the pixels of an image. The attackers embed the exploit code and the decoder code in the LSBs of the image, which facilitate the least visible aberration on the image, thereby making the image appear genuine.

The attackers write the exploit code in a high-level scripting language, for example, JavaScript® developed by Sun Microsystems, Inc., that is easily interpreted by a web browser. The exploit code performs an intended attack at the client device when the exploit code is executed. An attack to a computing device by an exploit code embedded in an image is herein referred to as a “stegosploit attack”. The decoder code contains information about the pixels of the image in which the exploit code is encoded by an attacker and provides support for executing the exploit code. The decoder code reconstructs the exploit code from the pixels of the image. The attacker uses steganography to embed the exploit code and the decoder code in an image and uploads the image onto web servers of compromised websites. An image with the embedded exploit code and decoder code is herein referred to as a “stegosploit image”. When a user's client device sends a request for a webpage to a web server of a compromised website through a web browser, the web server sends a response to the client device and displays the webpage of the compromised website along with a stegosploit image through the web browser on the client device. Since information of the webpage is typically stored in a hypertext markup language (HTML) file, the web browser reads the HTML file, extracts the information and images from the HTML file, and processes the extracted information and images to display the webpage on the user's client device. The attacker, therefore, spoofs the user by rendering the webpage with the stegosploit image as an HTML file on the web browser, which treats the webpage with the stegosploit image as an ordinary HTML file, and extracts and processes the information including the stegosploit image. Since the attacker uses steganography to hide the exploit code and the decoder code in the image, the user does not suspect the stegosploit image displayed on the webpage. When the user clicks on the stegosploit image, the decoder code decodes and executes the exploit code and performs an intended stegosploit attack on the user's client device.

Some conventional systems detect a stegosploit attack by performing a signature analysis or a behavior analysis of the stegosploit attack and terminating execution of the exploit code embedded in the stegosploit image. In the signature analysis, the exploit code is detected by inspecting a signature of the exploit code embedded in the stegosploit image. In the behavior analysis, the behavior of a stegosploit attack is inspected. Since an attacker changes the exploit code periodically, which in turn changes the behavior of the attack, it is difficult to detect the stegosploit attack using the behavior analysis of the attack. Since different exploit codes perform different types of attacks on the client device, it is difficult to detect the attacks by performing the signature analysis or the behavior analysis. Moreover, since the exploit code and the decoder code are hidden in an image using steganography, it is difficult to differentiate a stegosploit image from an original image. Furthermore, since consequences of the stegosploit attack depend on the type of the exploit code, there may not be a predefined signature or behavior associated with the stegosploit attack and hence there is a difficulty in detecting the stegosploit attack. Furthermore, these conventional systems attempt to reactively prevent or mitigate the stegosploit attack after the client device has been attacked already, which causes substantial damage to the client device prior to detection and mitigation of the stegosploit attack.

Hence, there is a long-felt need for a system and a method for proactively preventing a stegosploit attack by manipulating the pixels of a compromised image, that is, the stegosploit image, which disturbs, corrupts, or deactivates an exploit code and a decoder code embedded in the compromised image and renders the exploit code ineffective.

### Objects of the Embodiments Herein

An object of the embodiments disclosed herein is to provide a system and a method for preventing a stegosploit attack.

Another object of the embodiments disclosed herein is to provide a system and a method for proactively preventing a stegosploit attack by manipulating pixels of compromised images at a computing device, for example, a client device, prior to loading of the compromised images on the computing device.

Another object of the embodiments disclosed herein is to provide a system and a method for manipulating pixels of compromised images by implementing a filtering process, a compression process, and an encoding process on the compromised images.

Another object of the embodiments disclosed herein is to provide a system and a method for proactively preventing a stegosploit attack by deactivating an exploit code and a decoder code embedded in the pixels of each of the compromised images through pixel manipulation.

Another object of the embodiments disclosed herein is to provide a system and a method for replacing images extracted from a web server with a set of pixel-manipulated replacement images, prior to loading of the images on the computing device.

The objects disclosed above will be realized and achieved at least by the elements, features, and combinations particularly pointed out in the claims. The objects disclosed above have outlined, rather broadly, the features of the embodiments disclosed herein in order that the detailed description that follows is better understood. The objects disclosed above are not intended to determine the scope of the claimed subject matter and are not to be construed as limiting of the embodiments disclosed herein. Additional objects, features, and advantages of the embodiments herein are disclosed below. The objects disclosed above, which are believed to be characteristic of the embodiments disclosed herein, both as to its organization and method of operation, together with further objects, features, and advantages, will be better understood and illustrated by the technical features broadly embodied and described in the following description when considered in connection with the accompanying drawings.

### SUMMARY

This summary is provided to introduce a selection of concepts in a simplified form that are further disclosed in the detailed description. This summary is not intended to determine the scope of the claimed subject matter.

The various embodiments disclosed herein address the above-recited need for proactively preventing a stegosploit attack by manipulating pixels of a compromised image, that is, a stegosploit image, which disturbs, corrupts, or deactivates an exploit code and a decoder code embedded in the compromised image and renders the exploit code ineffective. Instead of detecting and thereafter preventing or attempting to mitigate a stegosploit attack, the various embodiments disclosed herein directly render an exploit code embedded in a compromised image ineffective to suppress the stegosploit attack on a user's computing device.

The various embodiments disclosed herein provide a stegosploit attack prevention engine (SAPE) for proactively preventing a stegosploit attack by pixel manipulation at a computing device, for example, a client device. The SAPE proactively prevents a stegosploit attack caused by images received through any one of multiple image rendering components, for example, a webpage, a web application, a messaging application, an electronic mail (email), a uniform resource locator (URL) link, etc. When the computing device requests for a webpage from a web server through a web browser deployed on the computing device, the web server delivers the webpage with one or more images. Each of the images comprises multiple pixels. Any one or more of these images is a compromised image comprising an exploit code and a decoder code embedded in the pixels of the compromised image. In an embodiment, the SAPE extracts the images from the webpage received from the web server, prior to loading of the images in the web browser. In an embodiment, the SAPE identifies an image tag corresponding to each of the images in a markup language code, for example, a hypertext markup language (HTML) code of the webpage. The SAPE then determines a source of each of the images identified by the corresponding image tag from the web server, extracts each of the images from the determined source, and assigns a unique identifier to each of the images.

The SAPE generates a replacement image for the compromised image by manipulating the pixels of the compromised image. The manipulation of the pixels of the compromised image deactivates the exploit code and the decoder code of the compromised image, thereby preventing the stegosploit attack. The SAPE generates a different replacement image for each image of the webpage. In an embodiment, the SAPE generates the replacement image for the compromised image by filtering the compromised image, compressing the filtered image for deactivating the exploit code and the decoder code of the compromised image, and encoding the compressed image. In an embodiment, the SAPE applies a subtraction filtering technique on the compromised image for filtering the compromised image. In an embodiment, the SAPE executes a deflate compression algorithm on the filtered image for compressing the filtered image. The deflate compression algorithm is a combination of a Lempel-Ziv compression algorithm and a Huffman coding algorithm.

In an embodiment, the SAPE encodes the compressed image by executing a Base64 encoding algorithm on the compressed image. By executing the Base64 encoding algorithm, the SAPE converts the compressed image into a binary stream, divides the binary stream into multiple blocks of predetermined sizes, divides each of the blocks of predetermined sizes into multiple sub-blocks of predetermined sizes, and maps each of the sub-blocks into a character encoding format. The character encoding format is, for example, an American Standard Code for Information Interchange (ASCII) string format. In an embodiment, the SAPE changes an orientation of the exploit code and the decoder code in the compressed image while encoding the compressed image. After the SAPE generates the replacement image with the manipulated pixels, the SAPE embeds the replacement image in place of the compromised image in the webpage and delivers the webpage with the replacement image to the web browser on the computing device. Similarly, the SAPE extracts images from any image rendering component, for example, a web application, a messaging application, an email, a URL link, etc.; generates replacement images for the compromised images received from the image rendering component by manipulating the pixels of the compromised images; embeds the replacement images in place of the compromised images in the image rendering component; and delivers the replacement images to the computing device.

In one or more embodiments, related systems comprise circuitry and/or programming for executing the methods disclosed herein. The circuitry and/or programming are of any combination of hardware, software, and/or firmware configured to execute the methods disclosed herein depending upon the design choices of a system designer. In an embodiment, various structural elements are employed depending on the design choices of the system designer.

### BRIEF DESCRIPTION OF THE DRAWINGS

The foregoing summary, as well as the following detailed description, is better understood when read in conjunction with the appended drawings. For illustrating the embodiments herein, exemplary constructions of the embodiments are shown in the drawings. However, the embodiments herein are not limited to the specific components and methods disclosed herein. The description of a component or a method step referenced by a numeral in a drawing is applicable to the description of that component or method step shown by that same numeral in any subsequent drawing herein.

FIG. 1 illustrates a block diagram of a system for proactively preventing a stegosploit attack, according to an embodiment herein.

FIG. 2 illustrates a flow diagram of a method for proactively preventing a stegosploit attack, according to an embodiment herein.

FIG. 3 illustrates a flowchart showing a method for extracting images of a webpage from a web server for pixel manipulation, according to an embodiment herein.

FIG. 4 illustrates a flowchart showing a method for manipulating pixels of compromised images, according to an embodiment herein.

FIG. 5 illustrates a flowchart showing a method for encoding a compressed image, according to an embodiment herein.

FIG. 6 illustrates an architectural block diagram of the system for proactively preventing a stegosploit attack, according to an embodiment herein.

FIGS. 7A-7D exemplarily illustrate schematic representations showing the method for proactively preventing a stegosploit attack, according to an embodiment herein.

The specific features of the embodiments herein are shown in some drawings and not in others for convenience only as each feature may be combined with any or all of the other features in accordance with the embodiments herein.

### DETAILED DESCRIPTION

Various aspects of the present disclosure may be embodied as a system, a method, or a non-transitory, computer-readable storage medium having one or more computer-readable program codes stored thereon. Accordingly, various embodiments of the present disclosure may take the form of an entirely hardware embodiment, an entirely software embodiment comprising, for example, microcode, firmware, software, etc., or an embodiment combining software and hardware aspects that may be referred to herein as a “system”, a “module”, an “engine”, a “circuit”, or a “unit”. For purposes of illustration, the detailed description refers to a system and a method for proactively preventing a stegosploit attack caused by stegosploit images embedded in a webpage received from a web server; however the scope of the system and the method disclosed herein is not limited to proactively preventing a stegosploit attack caused by stegosploit images embedded in a webpage but may be extended to proactively prevent a stegosploit attack caused by any stegosploit image received through any image rendering component, for example, a web application, a messaging application, electronic mail (email), a uniform resource locator (URL) link, etc.

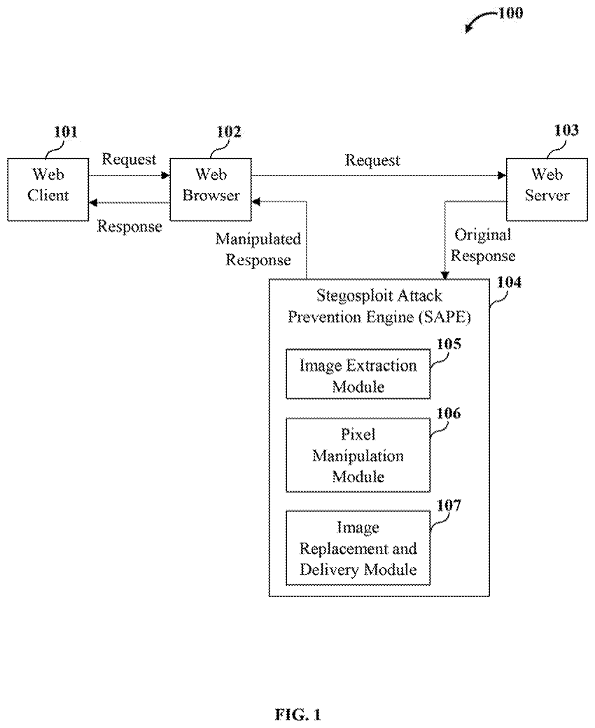

FIG. 1 illustrates a block diagram of a system 100 for proactively preventing a stegosploit attack, according to an embodiment herein. The system 100 disclosed herein comprises a stegosploit attack prevention engine (SAPE) 104 configured to communicate with a web browser 102, for example, the Mozilla® Firefox® browser of Mozilla Foundation, the Chrome® browser of Google LLC, the Internet Explorer® browser of Microsoft Corporation, etc., installed on a web client 101 of a computing device, for example, a client device or a client system, and a web server 103. In an embodiment, the web client 101 communicates with the web server 103 using an application protocol, for example, a hypertext transfer protocol (HTTP). When a user wishes to access a webpage of a website through the web browser 102, the web client 101 sends a request, for example, an HTTP request, for the webpage to the web server 103 through the web browser 102. The webpage may contain one or more compromised images, that is, stegosploit images. When the web server 103 sends an original response, for example, an HTTP response, intended for the web browser 102 on the computing device, the SAPE 104 intercepts the communication and proceeds to manipulate pixels of the images of the webpage to prevent a stegosploit attack.

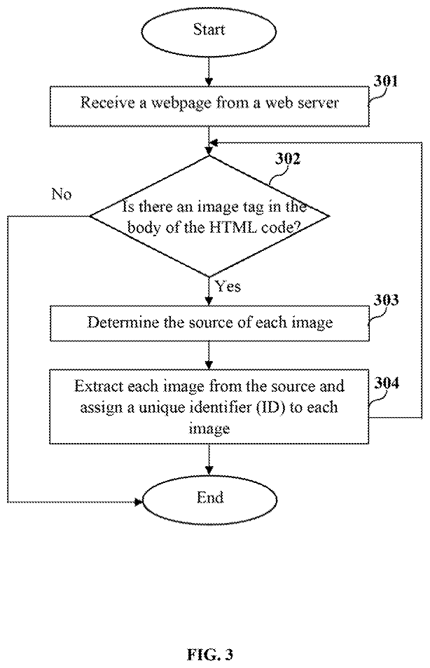

In an embodiment, the SAPE 104 comprises an image extraction module 105, a pixel manipulation module 106, and an image replacement and delivery module 107. The image extraction module 105 extracts all the images from the webpage received from the web server 103, prior to loading of the images in the web browser 102 on the computing device. Each of the images comprises multiple pixels. Any one or more of the images is a compromised image, that is, a stegosploit image, comprising an exploit code and a decoder code embedded in the pixels of the compromised image. In an embodiment, for extracting the images from the received webpage, the image extraction module 105 identifies an image tag corresponding to each of the images in a markup language code, for example, a hypertext markup language (HTML) code of the webpage, determines a source of each of the images identified by the corresponding image tag from the web server 103, extracts each of the images from the determined source, and assigns a unique identifier to each of the images as disclosed in the detailed description of FIG. 3.

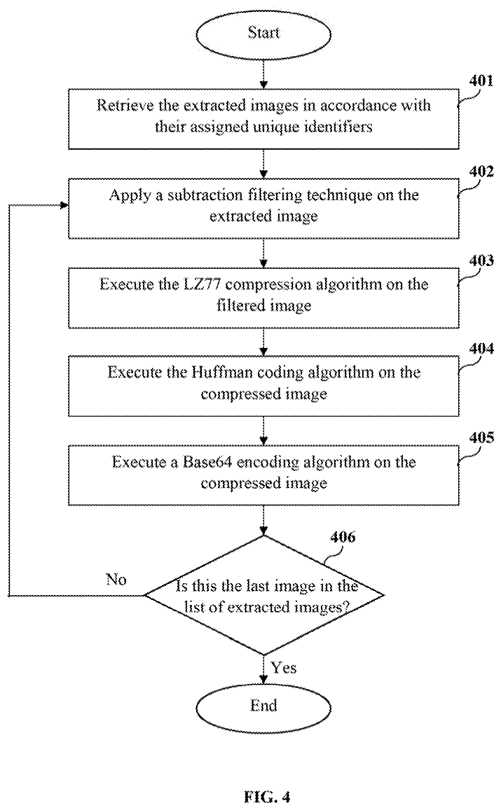

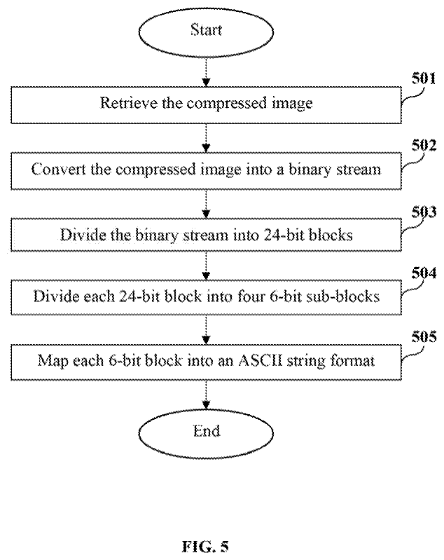

The extracted images of the webpage are input to the pixel manipulation module 106 and are transformed, processed, and executed by a combination of algorithms in the pixel manipulation module 106. The pixel manipulation module 106 generates a replacement image for the compromised image by manipulating the pixels of the compromised image. The manipulation of the pixels of the compromised image deactivates the exploit code and the decoder code of the compromised image. In an embodiment, for generating a replacement image for the compromised image, the pixel manipulation module 106 manipulates the pixels of the compromised image by filtering the compromised image, compressing the filtered image for deactivating the exploit code and the decoder code of the compromised image, and encoding the compressed image as disclosed in the detailed description of FIGS. 4-5. In an embodiment, the pixel manipulation module 106 applies a subtraction filtering technique on the compromised image for filtering the compromised image as disclosed in the detailed description of FIG. 4. In an embodiment, the pixel manipulation module 106 executes a deflate compression algorithm similar to a Portable Network Graphics (PNG) image compression on the filtered image for compressing the filtered image and deactivating the exploit code and the decoder code of the compromised image as disclosed in the detailed description of FIG. 4.

The deflate compression algorithm is a lossless data compression algorithm comprising a combination of a Lempel-Ziv (LZ) compression algorithm and a Huffman coding algorithm. In an embodiment, the LZ compression algorithm used herein is, for example, an LZ77 compression algorithm. By executing the LZ77 algorithm, the pixel manipulation module 106 compresses the filtered image by replacing repeated occurrences of image data with references to a single copy of that image data present earlier in an uncompressed data stream. Furthermore, by executing the Huffman coding algorithm, the pixel manipulation module 106 compresses the output image compressed by the execution of the LZ77 algorithm by assigning variable length codes to characters of the compressed image based on a frequency of occurrence of the characters in the compressed image. The Huffman coding algorithm implements a prefix rule that ensures that a variable length code assigned to any character is not a prefix of the variable length code assigned to any other character. By compressing the filtered image, the pixel manipulation module 106 deactivates, disturbs, and/or corrupts the exploit code and the decoder code embedded in the filtered image.

In an embodiment, the pixel manipulation module 106 encodes the compressed image by executing a Base64 encoding algorithm on the compressed image. The Base64 encoding algorithm is a binary-to-text encoding algorithm that maps binary data into text data and represents the binary data in a character encoding format. The character encoding format is, for example, an American Standard Code for Information Interchange (ASCII) string format. By executing the Base64 encoding algorithm, the pixel manipulation module 106 encodes the compressed image by converting the compressed image into a binary stream, dividing the binary stream into multiple blocks of predetermined sizes, dividing each of the blocks of the predetermined sizes into multiple sub-blocks of predetermined sizes, and mapping each of the sub-blocks into a character encoding format as disclosed in the detailed description of FIG. 5. In an embodiment, the pixel manipulation module 106 changes an orientation of the exploit code and the decoder code in the compressed image while encoding the compressed image.

After the pixel manipulation module 106 generates the replacement image with the manipulated pixels, the image replacement and delivery module 107 embeds the replacement image in place of the compromised image in the webpage and delivers the webpage with the replacement image as a manipulated response to the web browser 102, and in turn to the web client 101 on the computing device. The web client 101 receives the manipulated response through the web browser 102. Since information of the webpage is typically stored in an HTML file, the web browser 102 reads the HTML file, extracts the information and the replacement images from the HTML file, and processes the extracted information and replacement images to display the webpage on the user's computing device free of a stegosploit attack. As the exploit code and the decoder code are corrupted in the replacement images, the SAPE 104 prevents the stegosploit attack before the exploit code is executed in the computing device. In the system 100 disclosed herein, the SAPE 104 interfaces with the web client 101, the web browser 102, and the web server 103, and therefore more than one specifically programmed computer system is used for proactively preventing a stegosploit attack.

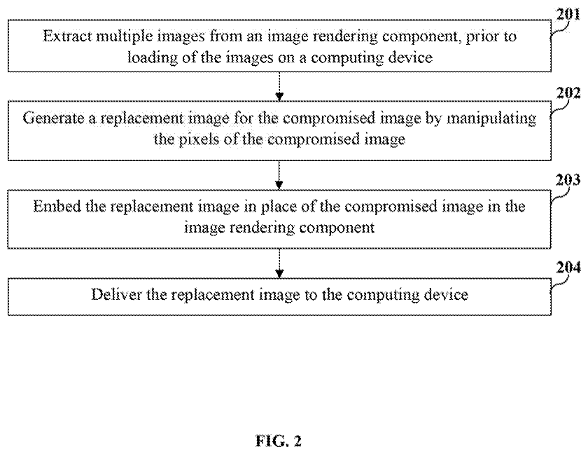

FIG. 2 illustrates a flow diagram of a method for proactively preventing a stegosploit attack, according to an embodiment herein. In the method disclosed herein, the stegosploit attack prevention engine (SAPE) 104 illustrated in FIG. 1, extracts 201 multiple images from an image rendering component, for example, a webpage, a web application, a messaging application, an email, a uniform resource locator (URL) link, etc., prior to loading of the images on a computing device; generates 202 a replacement image for the compromised image by manipulating the pixels of the compromised image; embeds 203 the replacement image in place of the compromised image in the image rendering component; and delivers 204 the replacement image to the computing device as disclosed in the detailed description of FIGS. 3-5.

FIG. 3 illustrates a flowchart showing a method for extracting images of a webpage from a web server for pixel manipulation, according to an embodiment herein. As illustrated in FIG. 3, the image extraction module 105 of the stegosploit attack prevention engine (SAPE) 104 illustrated in FIG. 1, receives 301 a webpage requested by a web browser on a computing device from the web server, thereby precluding a direct load of the webpage by the web browser and a possible stegosploit attack. The image extraction module 105 determines 302 whether there is an image tag in the body of the hypertext markup language (HTML) code of the webpage. The image tag, for example, <img> tag defines an image in a webpage written in the HTML code. Images are not inserted into a webpage but are linked to HTML webpages containing the images via uniform resource locators (URLs). The image tag acts as a holder for a linked image. The image tag comprises multiple attributes, for example, src, alt, etc. The “src” attribute refers to the URL of the image and the “alt” attribute refers to alternate text or a name assigned to the image. On receiving the webpage from the web server, the image extraction module 105 reads the HTML code of the webpage and searches for the image tag in the body of the HTML code. If there is an image tag in the body of the HTML code of the webpage, the image extraction module 105 determines 303 the source of the image in the webpage. The image extraction module 105 then extracts 304 the image from the source and assigns a unique identifier (ID) to the image. The image extraction module 105 continues to check 302 for image tags in the body of the HTML code of the webpage and proceeds with the steps 303 and 304 to extract all the images of the webpage. If the image extraction module 105 does not find an image tag in the body of the HTML code of the webpage, the image extraction module 105 terminates the extraction process.

FIG. 4 illustrates a flowchart showing a method for manipulating pixels of compromised images, according to an embodiment herein. In the method disclosed herein, the pixel manipulation module 106 of the stegosploit attack prevention engine (SAPE) 104 illustrated in FIG. 1, retrieves 401 the extracted images from the image extraction module 105 of the SAPE 104 illustrated in FIG. 1, in accordance with the assigned unique identifiers. The pixel manipulation module 106 sorts the extracted images in accordance with the assigned unique identifiers and performs the following pixel manipulation steps for each of the extracted images in a sorted order. The pixel manipulation module 106 receives the first extracted image from the sorted images and prepares the first extracted image for optimum compression by smoothening the first extracted image. In an embodiment, the pixel manipulation module 106 smoothens the first extracted image by applying 402 a subtraction filtering technique on the first extracted image. In the subtraction filtering technique, the pixel manipulation module 106 considers one pixel in the first extracted image as a reference pixel and performs encoding from the next pixel onwards. The pixel manipulation module 106 encodes the current pixel by performing a subtraction, that is, (current pixel value−previous pixel value). Consider an example where (54 34 56 20) are the values of four pixels in the first extracted image. The pixel manipulation module 106 applies the subtraction filtering technique on the four pixels and generates the following values (54−20 22−36). The subtraction filtering technique results in substantial duplication and the resultant low values allow further compression.

After application of the subtraction filtering technique on all the pixels of the first extracted image, the pixel manipulation module 106 executes a deflate compression algorithm, which is a combination of a Lempel-Ziv 1977 (LZ77) compression algorithm and a Huffman coding algorithm, on the filtered image as follows. The pixel manipulation module 106 first executes 403 the LZ77 compression algorithm on the filtered image. The LZ77 compression algorithm is a dictionary-based compression algorithm that analyzes the filtered image and reduces the size of the filtered image by replacing redundant information with metadata. For example, the LZ77 compression algorithm identifies duplicated strings in the input data, that is, the filtered image, and replaces the duplicated strings with a pointer to a previous string in the form of a (distance, length) pair. As used herein, the term “string” refers to an arbitrary sequence of bytes. The distance represents how far a duplicated string needs to go back to reach the start of an identical string. The length represents the number of characters for which the string is identical. After the pixel manipulation module 106 converts the filtered image into a compressed image comprising a string of characters and a (distance, length) pair by the execution of the LZ77 compression algorithm, the pixel manipulation module 106 executes 404 the Huffman coding algorithm on the compressed image. The Huffman coding algorithm receives the string of characters and the (distance, length) pair of the compressed image and attempts to reduce the number of bits required to present a string by converting a fixed length code into a variable length code.

After the pixel manipulation module 106 converts the fixed length code of each character of the compressed image into the variable length code using the Huffman coding algorithm, the pixel manipulation module 106 executes 405 a Base64 encoding algorithm on the compressed image. By executing the Base64 encoding algorithm, the pixel manipulation module 106 encodes the binary values of the pixels of the compressed image as disclosed in the detailed description of FIG. 5, which further affects the orientation of the exploit code and the decoder code embedded in the compressed image. The pixel manipulation module 106 then determines 406 whether the compressed image is the last image among the sorted images. If the compressed image is not the last image among the sorted images, the pixel manipulation module 106 proceeds to perform the steps 402, 403, 404, and 405 on each of the remaining images in the sorted order until the pixels of all the extracted images are manipulated and the exploit code and the decoder code embedded therein are deactivated. If the compressed image is the last image among the sorted images, the pixel manipulation module 106 terminates the pixel manipulation process.

FIG. 5 illustrates a flowchart showing a method for encoding a compressed image, according to an embodiment herein. In this embodiment, after compression of the filtered image by the execution of the deflate compression algorithm, the pixel manipulation module 106 of the stegosploit attack prevention engine (SAPE) 104 illustrated in FIG. 1, encodes the compressed image by executing the Base64 encoding algorithm on the compressed image. The Base64 encoding algorithm represents binary data of the compressed image in an American Standard Code for Information Interchange (ASCII) string format by translating the binary data into a radix-64 representation. The Base64 encoding algorithm, therefore, encodes the binary data, that is, a stream of bytes into a stream of 64-printable characters. Each Base64 digit represents 6 bits of data. Therefore, three bytes of 8 bits each are, therefore, represented by four 6-bit Base64 digits.

As illustrated in FIG. 5, the pixel manipulation module 106 retrieves 501 the compressed image output from the execution of the deflate compression algorithm and converts 502 the compressed image into a binary stream. The pixel manipulation module 106 then divides 503 the binary stream into 24-bit blocks. If the last block is less than 24 bits, the pixel manipulation module 106 appends a padding bit and padding characters to the last block. The pixel manipulation module 106 then divides 504 each of the 24-bit blocks into four 6-bit sub-blocks. The pixel manipulation module 106 then maps 505 each 6-bit sub-block into a character encoding format, for example, the ASCII string format. That is, the pixel manipulation module 106 converts each 6-bit sub-block into decimal values, which in turn, is mapped into ASCII characters. By executing the Base64 encoding algorithm, the pixel manipulation module 106 increases the size of the original image, for example, by about 33%. In a stegosploit attack, the decoder code has the information about the pixels of the image in which the exploit code is embedded by an attacker. Since the pixel manipulation module 106 increases the size of the image by the encoding process, the location information that the decoder code holds become invalid and not usable to execute the stegosploit attack. The pixel manipulation module 106, therefore, prevents the stegosploit attack before the exploit code is executed. After completion of the pixel manipulation of all the extracted images in the webpage, the image replacement and delivery module 107 of the SAPE 104 illustrated in FIG. 1, replaces the original images, that are extracted from the webpages before being delivered to the web browser, with the pixel-manipulated, replacement images, and delivers the replacement images to the web browser. The image replacement and delivery module 107 embeds the replacement images in the hypertext markup language (HTML) document of the webpage and delivers the webpage to the web browser.

The system and the method disclosed herein implement one or more specific computer programs for proactively preventing a stegosploit attack. The system and the method disclosed herein improve the functionality of a computer and provide an improvement in cybersecurity and computer protection technology related to proactively preventing a stegosploit attack as follows: On implementing the method disclosed herein, the image extraction module 105 of the SAPE 104 illustrated in FIG. 1, extracts all the images from an image rendering component, for example, webpage, prior to loading of the images in a web browser on a computing device as disclosed in the detailed description of FIG. 3. Then, the pixel manipulation module 106, through the use of separate and autonomous computer programs, generates a replacement image for each of the images including compromised images by manipulating the pixels of each image using filtering, compression and encoding processes as disclosed in the detailed description of FIGS. 1-2 and FIGS. 4-5. The manipulation of the pixels of each of the compromised images deactivates any exploit code and any decoder code embedded therein. Furthermore, the image replacement and delivery module 107 embeds the replacement image in place of each image in the webpage and delivers the webpage with the replacement images to the web browser on the computing device.

The focus of the system and the method disclosed herein is on an improvement to cybersecurity technology and computer functionalities for proactively preventing a stegosploit attack, and not on tasks for which a generic computer is used in its ordinary capacity. Rather, the system and the method disclosed herein are directed to a specific improvement to the way processors in the system operate, embodied in, for example, extracting all the images from a webpage received from a web server, prior to loading of the images in a web browser on a computing device; generating a replacement image for each extracted image by manipulating the pixels of each extracted image; and embedding the replacement image in place of each corresponding extracted image in the webpage and delivering the webpage with the replacement images to the web browser on the computing device.

In the method disclosed herein, the design and the flow of data and interactions between the web client 101, the web browser 102, the web server 103, and the SAPE 104 of the system 100 illustrated in FIG. 1, are deliberate, designed, and directed. The interactions between the web client 101, the web browser 102, the web server 103, and the SAPE 104 allow the system 100 to proactively prevent a stegosploit attack. The method steps performed by the SAPE 104 disclosed above require three or more separate computer programs and subprograms, the execution of which cannot be performed by a person using a generic computer with a generic program. The method steps performed by the SAPE 104 disclosed above are tangible, provide useful results, and are not abstract. The hardware and software implementation of the SAPE 104 disclosed herein and one or more processors is an improvement in cybersecurity and computer protection technology.

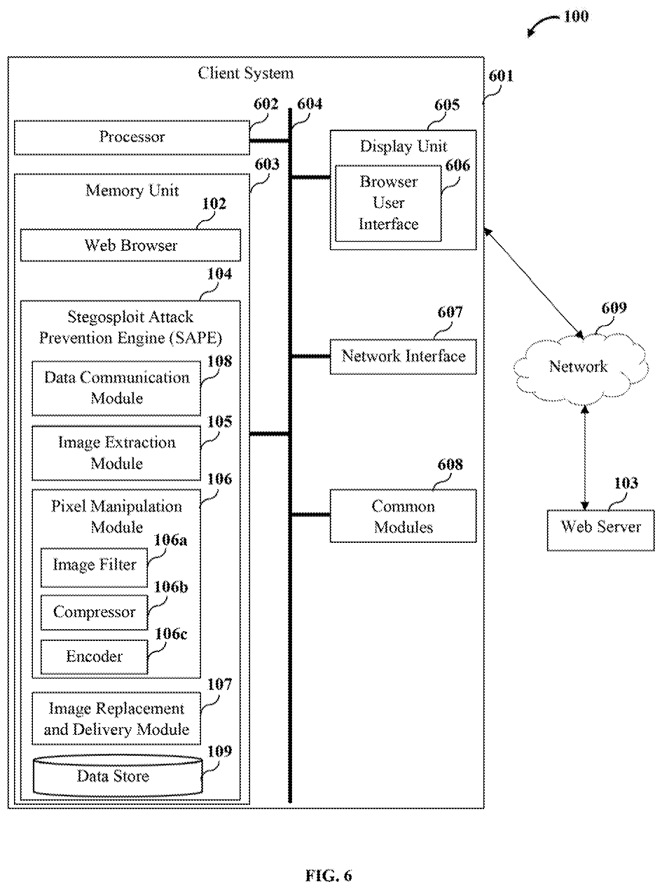

FIG. 6 illustrates an architectural block diagram of the system 100 for proactively preventing a stegosploit attack, according to an embodiment herein. In an embodiment, the stegosploit attack prevention engine (SAPE) 104 is deployed in a computing device, for example, a client system 601. The client system 601 hosts a web browser 102 and renders a browser user interface 606 on a display unit 605 of the client system 601. The SAPE 104 in the client system 601 communicates with a web server 103 via a network 609, for example, a short-range network or a long-range network. The network 609 is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks.

The client system 601 is a computer system programmable using high-level computer programming languages. The client system 601 is an electronic device, for example, one or more of a personal computer, a tablet computing device, a mobile computer, a mobile phone, a smart phone, a portable computing device, a laptop, a personal digital assistant, a wearable computing device such as smart glasses, a smart watch, etc., a touch centric device, a workstation, a client device, a portable electronic device, a network enabled computing device, an interactive network enabled communication device, a gaming device, an image capture device, a video recorder, an audio recorder, a theater system, any entertainment system, any other suitable computing equipment, combinations of multiple pieces of computing equipment, etc. In an embodiment, the SAPE 104 is implemented in the client system 601 using programmed and purposeful hardware. The SAPE 104 is a computer-embeddable system that protects the client system 601 from a stegosploit attack. In an embodiment, the SAPE 104 is configured as a security plug-in that operates within a predetermined space of an operating system of the client system 601. In another embodiment, the SAPE 104 is implemented in a cloud computing environment. As used herein, “cloud computing environment” refers to a processing environment comprising configurable computing physical and logical resources, for example, networks, servers, storage media, virtual machines, applications, services, etc., and data distributed over the network 609. The cloud computing environment provides an on-demand network access to a shared pool of the configurable computing physical and logical resources. In an embodiment, the SAPE 104 is a cloud computing-based platform implemented as a service for proactively preventing a stegosploit attack. In another embodiment, the SAPE 104 is implemented as an on-premise platform comprising on-premise software installed and run on client systems on the premises of an organization.

As illustrated in FIG. 6, the client system 601 comprises a non-transitory, computer-readable storage medium, for example, a memory unit 603 for storing computer program instructions defined by modules, for example, 105, 106, 107, 108, etc., of the SAPE 104. As used herein, “non-transitory, computer-readable storage medium” refers to all computer-readable media, for example, non-volatile media, volatile media, and transmission media, except for a transitory, propagating signal. Non-volatile media comprise, for example, solid state drives, optical discs or magnetic disks, flash memory cards, a read-only memory (ROM), etc. Volatile media comprise, for example, a register memory, a processor cache, a random-access memory (RAM), etc. Transmission media comprise, for example, coaxial cables, copper wire, fiber optic cables, modems, etc., including wires that constitute a system bus coupled to a processor.

The client system 601 further comprises a processor 602 operably and communicatively coupled to the memory unit 603 for executing the computer program instructions defined by the modules, for example, 105, 106, 107, 108, etc., of the SAPE 104. The memory unit 603 is used for storing program instructions, applications, and data. In an embodiment, the memory unit 603 is a random-access memory (RAM) or another type of dynamic storage device that stores information and instructions for execution by the processor 602. The memory unit 603 also stores temporary variables and other intermediate information used during execution of the instructions by the processor 602. In an embodiment, the client system 601 further comprises a read only memory (ROM) or other types of static storage devices that store static information and instructions for execution by the processor 602. In an embodiment, the modules, for example, 105, 106, 107, 108, etc., of the SAPE 104 are stored in the memory unit 603.

The processor 602 is configured to execute the computer program instructions defined by the modules, for example, 105, 106, 107, 108, etc., of the SAPE 104 for proactively preventing a stegosploit attack. The processor 602 refers to any one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In an embodiment, the processor 602 is implemented as a processor set comprising, for example, a programmed microprocessor and a math or graphics co-processor. The SAPE 104 is not limited to employing the processor 602. In an embodiment, the SAPE 104 employs a controller or a microcontroller. The processor 602 executes the modules, for example, 105, 106, 107, 108, etc., of the SAPE 104.

As illustrated in FIG. 6, the client system 601 further comprises a data bus 604, the display unit 605, a network interface 607, and common modules 608. The data bus 604 permits communications between the modules, for example, 602, 603, 605, 607, and 608 of the client system 601. The display unit 605, via the browser user interface 606, displays information, images, display interfaces, user interface elements such as checkboxes, input text fields, etc., for example, for allowing a user to request for a webpage from the web server 103 through the web browser 102 and view the webpage delivered by the SAPE 104. The client system 601 renders the browser user interface 606 on the display unit 605 for receiving inputs from the user. The browser user interface 606 comprises, for example, an online web interface, a web-based downloadable application interface, a mobile-based downloadable application interface, etc. The display unit 605 displays the browser user interface 606.

The network interface 607 enables connection of the client system 601 to the network 609. In an embodiment, the network interface 607 is provided as an interface card also referred to as a line card. The network interface 607 is, for example, one or more of infrared interfaces, interfaces implementing Wi-Fi® of Wi-Fi Alliance Corporation, universal serial bus interfaces, FireWire® interfaces of Apple Inc., Ethernet interfaces, frame relay interfaces, cable interfaces, digital subscriber line interfaces, token ring interfaces, peripheral controller interconnect interfaces, local area network interfaces, wide area network interfaces, interfaces using serial protocols, interfaces using parallel protocols. Ethernet communication interfaces, asynchronous transfer mode interfaces, high speed serial interfaces, fiber distributed data interfaces, interfaces based on transmission control protocol (TCP)/internet protocol (IP), interfaces based on wireless communications technology such as satellite technology, radio frequency technology, near field communication, etc. The common modules 608 of the client system 601 comprise, for example, input/output (I/O) controllers, input devices, output devices, fixed media drives such as hard drives, removable media drives for receiving removable media, etc. Computer applications and programs are used for operating the client system 601. The programs are loaded onto fixed media drives and into the memory unit 603 via the removable media drives. In an embodiment, the computer applications and programs are loaded into the memory unit 603 directly via the network 609.

In an exemplary implementation illustrated in FIG. 6, the SAPE 104 comprises a data communication module 108, the image extraction module 105, the pixel manipulation module 106, the image replacement and delivery module 107, and a data store 109, stored in the memory unit 603 and executed by the processor 602 in the client system 601. When a user enters a request to access a webpage of a website through the web browser 102 using the browser user interface 606 on the client system 601, the web browser 102 sends the request, for example, a hypertext transfer protocol (HTTP) request, for the webpage to the web server 103 via the network 609. When the web server 103 sends an original response, for example, an HTTP response, intended for the web browser 102 on the client system 601, the data communication module 108 of the SAPE 104 intercepts the communication and receives the webpage to prevent a stegosploit attack. The image extraction module 105 extracts all the images from the webpage, prior to loading of the images in the web browser 102 on the client system 601 as disclosed in the detailed description of FIG. 1 and FIG. 3. In an embodiment, the pixel manipulation module 106 comprises an image filter 106a, a compressor 106b, and an encoder 106c. In an embodiment, the image filter 106a filters each of the extracted images by applying a subtraction filtering technique on each of the extracted images as disclosed in the detailed description of FIG. 1 and FIG. 4. In an embodiment, the compressor 106b compresses each of the filtered images for deactivating any exploit code and any decoder code embedded therein by executing a deflate compression algorithm, that is, a combination of the LZ77 compression algorithm and the Huffman coding algorithm on each filtered image as disclosed in the detailed description of FIG. 1 and FIG. 4. In an embodiment, the encoder 106c encodes each of the compressed images by executing the Base64 encoding algorithm on each compressed image to generate a replacement image for each compressed image as disclosed in the detailed description of FIG. 1 and FIG. 5.

The image replacement and delivery module 107 embeds the replacement images in place of the extracted images in the webpage and delivers the webpage with the replacement images to the web browser 102 via the browser user interface 606 on the client system 601. In an embodiment, the data communication module 108 receives the webpage with the replacement images from the image replacement and delivery module 107 and transmits the webpage to the web browser 102 for rendering on the browser user interface 606. The data store 109 is any storage area or medium that can be used for storing data, images, and files. In an embodiment, the data store 109 is any of a structured query language (SQL) data store or a not only SQL (NoSQL) data store. In an embodiment, the data store 109 is a location on a file system. In another embodiment, the data store 109 is configured to be remotely accessible by the SAPE 104 in the client system 601 via the network 609. In another embodiment, the data store 109 is configured as a cloud-based database implemented in a cloud computing environment.

The data communication module 108, the image extraction module 105, the image filter 106a, the compressor 106b, and the encoder 106c of the pixel manipulation module 106, and the image replacement and delivery module 107 are disclosed above as software executed by the processor 602. In an embodiment, the modules, for example, 105, 106, 107, 108, etc., of the SAPE 104 are implemented completely in hardware. In another embodiment, the modules, for example, 105, 106, 107, 108, etc., of the SAPE 104 are implemented by logic circuits to carry out their respective functions disclosed above. In another embodiment, the SAPE 104 is also implemented as a combination of hardware and software and one or more processors, for example, 602, that are used to implement the modules, for example, 105, 106, 107, 108, etc., of the SAPE 104.

For purposes of illustration, the detailed description refers to the modules, for example, 105, 106, 107, 108, etc., of the SAPE 104 being run locally on a single client system 601; however the scope of the system 100 and the method disclosed herein is not limited to the modules, for example, 105, 106, 107, 108, etc., of the SAPE 104 being run locally on a single client system 601 via the operating system and the processor 602, but may be extended to run remotely over the network 609 by employing the web browser 102 and a remote server, a mobile phone, or other electronic devices. In an embodiment, one or more portions of the system 100 disclosed herein are distributed across one or more computer systems (not shown) coupled to the network 609.

The non-transitory, computer-readable storage medium disclosed herein stores computer program instructions executable by the processor 602 for proactively preventing a stegosploit attack. The computer program instructions implement the processes of various embodiments disclosed above and perform additional steps that may be required and contemplated for proactively preventing a stegosploit attack. When the computer program instructions are executed by the processor 602, the computer program instructions cause the processor 602 to perform the steps of the method for proactively preventing a stegosploit attack as disclosed in the detailed descriptions of FIGS. 2-5. In an embodiment, a single piece of computer program code comprising computer program instructions performs one or more steps of the method disclosed in the detailed descriptions of FIGS. 2-5. The processor 602 retrieves these computer program instructions and executes them.

A module, or an engine, or a unit, as used herein, refers to any combination of hardware, software, and/or firmware. As an example, a module, or an engine, or a unit includes hardware, such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, Java®, JavaScript®, a hypertext markup language (HTML), etc. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

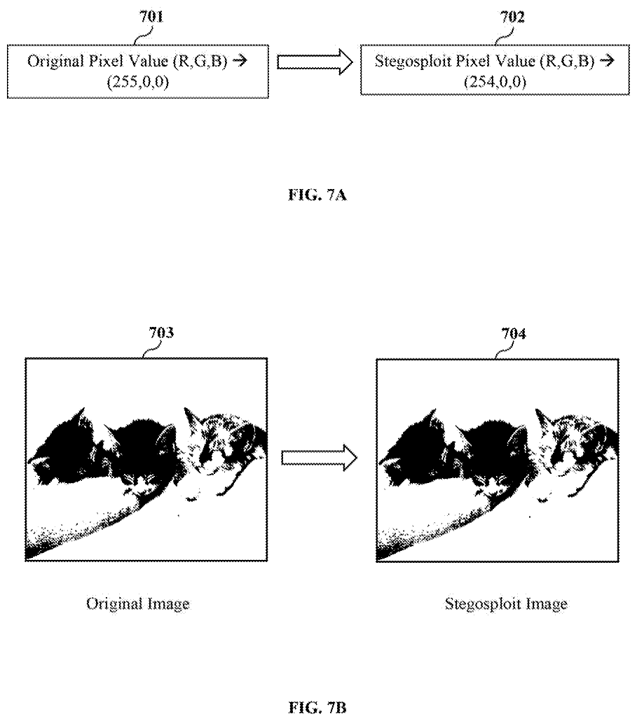

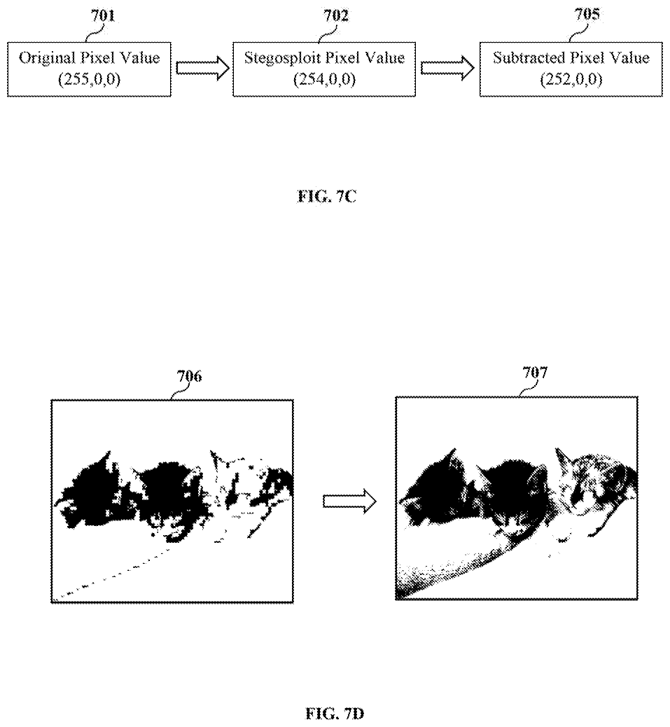

FIGS. 7A-7D exemplarily illustrate schematic representations showing the method for proactively preventing a stegosploit attack, according to an embodiment herein. Consider an example where a stegosploit attacker sends attractive stegosploit images to a computing device, for example, a smart phone, of a target user and tempts the target user to click on the stegosploit images. The stegosploit attacker uses the stegosploit images to perform surveillance on the target user's computing device, hijack or gain a complete access control of the target user's computing device, modify a system configuration of the target user's computing device, etc. If the target user clicks any of the stegosploit images, the exploit code embedded in the stegosploit images is executed on the computing device and operates in accordance with instructions defined in the exploit code.

The exploit code and the decoder code are embedded and hidden, for example, in a least significant bit (LSB) of an image using steganography to create a stegosploit image. If three bits in an eight-bit pixel of an original image are changed as illustrated in FIG. 7A, then changes in the image are not noticeable. For example, a stegosploit attacker changes three bits in an eight-bit pixel of an original image from (255,0,0) 701 to (254,0,0) 702 as illustrated in FIG. 7A. The stegosploit attacker, therefore, embeds the exploit code and the decoder code in the LSB of an original image 703 and converts the original image 703 into the stegosploit image 704 as illustrated in FIG. 7B. Since the exploit code and the decoder code are hidden in the LSB of the stegosploit image 704, it is difficult to differentiate the stegosploit image 704 from the original image 703 as the changes in the image are not noticeable as illustrated in FIG. 7B. Consider an example where the stegosploit attacker sends the stegosploit image 704 to the target user's computing device, for example, via an electronic mail (email), a webpage, a messaging application, etc., and tempts the target user to click on the stegosploit image 704 and execute the stegosploit attack.

To preclude the execution of the exploit code and the decoder code on the target user's computing device, the stegosploit attack prevention engine (SAPE) 104 illustrated in FIG. 1 and FIG. 6, extracts the stegosploit image 704, prior to loading of the stegosploit image 704 in a web browser or a web application on the computing device, and generates a replacement image for the stegosploit image 704 by manipulating the pixels of the stegosploit image 704 using a filtering process, a compression process, and an encoding process as disclosed in the detailed descriptions of FIGS. 4-5. The SAPE 104 applies a subtraction filtering technique by subtracting the value of each pixel in the stegosploit image 704, for example, by 1 or 2 or 3 such that the change will not be noticeable in the resultant replacement image as illustrated in FIG. 7C. For example, the SAPE 104 subtracts the value of the pixel in the stegosploit image 704 by 2, thereby resulting in a change of the three bits in the eight-bit pixel of the stegosploit image 704 from (254,0,0) 702 to (252,0,0) 705 as illustrated in FIG. 7C. Since the exploit code and the decoder code are hidden in the LSB of the stegosploit image 704, for example, the last 3 bits of the stegosploit image 704, the subtraction filtering technique applied by the SAPE 104 damages the exploit code and the decoder code. To further improve the pixel manipulation, the SAPE 104 executes the deflate compression algorithm and the Base64 encoding algorithm on the filtered image.

FIG. 7D illustrates the output replacement images 706 and 707 generated by the SAPE 104 after pixel manipulation. The SAPE 104 sets a quality index for generation of a replacement image. The quality index is configurable, for example, from 0 to 10. The quality index determines a degree of loss in the compression and the resulting quality of the replacement image. If the quality index is set to 0, the SAPE 104 performs a compression to produce a low quality replacement image. If the quality index is set to 10, the SAPE 104 performs a lossless compression on the image to produce a high quality replacement image. In an embodiment, the SAPE 104 implements a lossless compression by reducing the size of the image without compromising the quality of the image. In an embodiment, since a high quality image with a minimal amount of data discard is required, the SAPE 104 sets the quality index, for example, to 9, which results in small changes in the image, which in turn, results in damaging the exploit code and the decoder code in the image. A replacement image 706 having a compression quality index set to 0 and a replacement image 707 having a compression quality index set to 9 are illustrated in FIG. 7D.

The SAPE 104 executes the Base64 encoding algorithm to map binary data into text data, as performed for a multipurpose internet mail extensions (MIME) content transfer in a network because some underlying devices in the network are configured to operate on text data and not binary data. If the binary data is sent to such an underlying device, the underlying device may construe the binary data as control bits and perform a control operation in the network. The Base64 encoding algorithm is, therefore, executed to encode the binary data into text data that needs to be stored and transferred to such an underlying device.

In the system and the method disclosed herein, after compressing the filtered image using the deflate compression algorithm as disclosed in the detailed description of FIG. 4, the SAPE 104 converts the compressed image into text data by executing the Base64 encoding algorithm and delivers the replacement image 706 or 707 with the text data to the web browser or the web application, thereby preventing the stegosploit attack. During the execution of the Base64 encoding algorithm, the SAPE 104 extracts the first three pixels with the size of 8 bits from the compressed image and converts the three pixels into a binary stream. In an example, if the pixel values of the three pixels are 154, 163, and 235, the SAPE 104 generates the resultant binary stream as 10011010 10100011 11101011. The SAPE 104 then divides the binary stream into six-bit words or blocks, for example, as 100110 101010 001111 101011 which are equivalent to 38 42 15 43. The SAPE 104 then maps these values to ASCII characters, resulting in & * +. By converting the binary stream to text data, the size of the pixel manipulated image is increased, for example, by about 33%. Since the size of the pixel manipulated image is increased due to the encoding process, the information about the pixels of the image and their locations held by the decoder code become invalid and not usable to execute the stegosploit attack. The SAPE 104 replaces the stegosploit image 704 with the pixel manipulated replacement image 706 or 707 and delivers the pixel manipulated replacement image 706 or 707 to the target user's computing device. The SAPE 104, therefore, prevents the stegosploit attack before the exploit code is executed by the decoder code.

The system and the method disclosed herein protect a computing device, for example, a client system, that connects to a network, for example, the internet, from stegosploit attacks. The system and the method disclosed herein prevent the stegosploit attack by manipulating the pixels of the images of a webpage, which deactivates and renders the exploit code and the decoder code embedded in the images ineffective. The SAPE 104 thwarts the reconstruction of the exploit code within the web browser by the decoder code. As the decoder code is dependent on an exact arrangement of pixels in an image for reconstructing the exploit code, the manipulation of the pixels of the images by the SAPE 104 prevents the stegosploit attack. To obliterate the intent of the decoder code, the SAPE 104 disturbs the original arrangement of the pixels in the image so that the decoder code fails to decode the exploit code from the pixels of the image. By performing the pixel manipulation, the SAPE 104 disturbs both the exploit code and the decoder code encoded in the image. The proactive method of preventing the stegosploit attack provides improved security to the computing device as the consequence of the stegosploit attack is prevented in the client environment. Since the behavior of the stegosploit attack changes periodically by merely changing the exploit codes embedded in the images of webpages, the SAPE 104 implements a disruptive method of suppressing the stegosploit attack at the application level itself. Instead of detecting the stegosploit attack and then preventing the stegosploit attack or attempting to mitigate the effects and/or consequences of the stegosploit attack, the SAPE 104 directly renders the exploit codes and the decoder codes embedded in the images of the webpages ineffective to suppress the stegosploit attack. The SAPE 104 is capable of being implemented in association with all web browsers, because the SAPE 104 provides a preventive measure against the browser-based stegosploit attack.

It is apparent in different embodiments that the various methods, algorithms, and computer-readable programs disclosed herein are implemented on non-transitory, computer-readable storage media appropriately programmed for computing devices. The non-transitory, computer-readable storage media participate in providing data, for example, instructions that are read by a computer, a processor, or a similar device. In different embodiments, the “non-transitory, computer-readable storage media” also refer to a single medium or multiple media, for example, a centralized database, a distributed database, and/or associated caches and servers that store one or more sets of instructions that are read by a computer, a processor or a similar device. The “non-transitory, computer-readable storage media” also refer to any medium capable of storing or encoding a set of instructions for execution by a computer, a processor or a similar device and that causes a computer, a processor or a similar device to perform any one or more of the steps of the method disclosed herein. In an embodiment, the computer programs that implement the methods and algorithms disclosed herein are stored and transmitted using a variety of media, for example, the computer-readable media in various manners. In an embodiment, hard-wired circuitry or custom hardware is used in place of, or in combination with, software instructions for implementing the processes of various embodiments. Therefore, the embodiments are not limited to any specific combination of hardware and software. In another embodiment, various aspects of the system and the method disclosed herein are implemented in a non-programmed environment comprising documents created, for example, in a hypertext markup language (HTML), an extensible markup language (XML), or other format that render aspects of the browser user interface or perform other functions, when viewed in a visual area or a window of a browser program. In another embodiment, various aspects of the system and the method disclosed herein are implemented as programmed elements, or non-programmed elements, or any suitable combination thereof.

Where databases are described such as the data store 109 illustrated in FIG. 6, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, object methods or behaviors of a database are used to implement various processes such as those disclosed herein. In another embodiment, the databases are, in a known manner, stored locally or remotely from a device that accesses data in such a database. In embodiments where there are multiple databases, the databases are integrated to communicate with each other for enabling simultaneous updates of data linked across the databases, when there are any updates to the data in one of the databases.

The embodiments disclosed herein are not limited to a particular computer system platform, processor, operating system, or network. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network using a communication protocol. The embodiments disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be executed and changes may be made thereto, without departing from the scope and spirit of the embodiments disclosed herein.

What is claimed is:

1. A system for proactively preventing a stegosploit attack, the system comprising:
at least one processor;
a non-transitory, computer-readable storage medium operably and communicatively coupled to the at least one processor and configured to store computer program instructions executable by the at least one processor; and
a stegosploit attack prevention engine configured to define the computer program instructions, which when executed by the at least one processor, cause the at least one processor to:
extract a plurality of images from an image rendering component, prior to loading of the images on a computing device, wherein each of the images comprises a plurality of pixels, and wherein any one or more of the images is a compromised image comprising an exploit code and a decoder code embedded in the pixels of the compromised image;
generate a replacement image for the compromised image by manipulating the pixels of the compromised image, wherein the manipulation of the pixels of the compromised image deactivates the exploit code and the decoder code of the compromised image; and
embed the replacement image in place of the compromised image in the image rendering component and deliver the replacement image to the computing device.

2. The system according to claim 1, wherein the image rendering component is one of a webpage, a web application, a messaging application, an electronic mail, and a uniform resource locator link.

3. The system according to claim 1, wherein the stegosploit attack prevention engine is configured to define additional computer program instructions for extracting the images from the image rendering component, which when executed by the at least one processor, cause the at least one processor to:
identify an image tag corresponding to the each of the images in a markup language code of the image rendering component, wherein the image rendering component is a webpage;
determine a source of the each of the images identified by the corresponding image tag;
extract the each of the images from the determined source; and
assign a unique identifier to the each of the images.

4. The system according to claim 1, wherein the stegosploit attack prevention engine is configured to define additional computer program instructions for generating the replacement image for the compromised image, which when executed by the at least one processor, cause the at least one processor to:
filter the compromised image;
compress the filtered image for deactivating the exploit code and the decoder code of the compromised image; and
encode the compressed image.

5. The system according to claim 4, wherein the additional computer program instructions defined by the stegosploit attack prevention engine for filtering the compromised image, when executed by the at least one processor, cause the at least one processor to apply a subtraction filtering technique on the compromised image.

6. The system according to claim 4, wherein the additional computer program instructions defined by the stegosploit attack prevention engine for compressing the filtered image, when executed by the at least one processor, cause the at least one processor to execute a deflate compression algorithm on the filtered image, and wherein the deflate compression algorithm is a combination of a Lempel-Ziv compression algorithm and a Huffman coding algorithm.

7. The system according to claim 4, wherein the additional computer program instructions defined by the stegosploit attack prevention engine for encoding the compressed image, when executed by the at least one processor, cause the at least one processor to execute a Base64 encoding algorithm on the compressed image comprising:
converting the compressed image into a binary stream;
dividing the binary stream into a plurality of blocks of predetermined first sizes;
dividing each of the blocks of the predetermined first sizes into a plurality of sub-blocks of predetermined second sizes; and
mapping each of the sub-blocks into a character encoding format.

8. The system according to claim 7, wherein the character encoding format is an American Standard Code for Information Interchange string format.

9. The system according to claim 4, wherein the additional computer program instructions defined by the stegosploit attack prevention engine for encoding the compressed image, when executed by the at least one processor, cause the at least one processor to change an orientation of the exploit code and the decoder code in the compressed image.

10. A method for proactively preventing a stegosploit attack, the method comprising:
extracting, by a stegosploit attack prevention engine, a plurality of images from an image rendering component, prior to loading of the images on a computing device, wherein each of the images comprises a plurality of pixels, and wherein any one or more of the images is a compromised image comprising an exploit code and a decoder code embedded in the pixels of the compromised image;
generating a replacement image for the compromised image by manipulating the pixels of the compromised image by the stegosploit attack prevention engine, wherein the manipulation of the pixels of the compromised image deactivates the exploit code and the decoder code of the compromised image; and
embedding the replacement image in place of the compromised image in the image rendering component and delivering the replacement image to the computing device by the stegosploit attack prevention engine.

11. The method according to claim 10, wherein the image rendering component is one of a webpage, a web application, a messaging application, an electronic mail, and a uniform resource locator link.

12. The method according to claim 10, wherein the extraction of the images from the image rendering component comprises:
identifying an image tag corresponding to the each of the images in a markup language code of the image rendering component by the stegosploit attack prevention engine, wherein the image rendering component is a webpage;
determining, by the stegosploit attack prevention engine, a source of the each of the images identified by the corresponding image tag;
extracting the each of the images from the determined source by the stegosploit attack prevention engine; and
assigning a unique identifier to the each of the images by the stegosploit attack prevention engine.

13. The method according to claim 10, wherein the generation of the replacement image for the compromised image comprises:
filtering the compromised image by the stegosploit attack prevention engine;
compressing the filtered image by the stegosploit attack prevention engine for deactivating the exploit code and the decoder code of the compromised image; and
encoding the compressed image by the stegosploit attack prevention engine.

14. The method according to claim 13, wherein the compromised image is filtered by the stegosploit attack prevention engine by applying a subtraction filtering technique on the compromised image.

15. The method according to claim 13, wherein the filtered image is compressed by the stegosploit attack prevention engine by executing a deflate compression algorithm on the filtered image, and wherein the deflate compression algorithm is a combination of a Lempel-Ziv compression algorithm and a Huffman coding algorithm.

16. The method according to claim 13, wherein the compressed image is encoded by the stegosploit attack prevention engine by executing a Base64 encoding algorithm on the compressed image, and wherein the execution of the Base64 encoding algorithm on the compressed image comprises:
converting the compressed image into a binary stream by the stegosploit attack prevention engine;
dividing the binary stream into a plurality of blocks of predetermined first sizes by the stegosploit attack prevention engine;
dividing each of the blocks of the predetermined first sizes into a plurality of sub-blocks of predetermined second sizes by the stegosploit attack prevention engine; and
mapping each of the sub-blocks into a character encoding format by the stegosploit attack prevention engine.

17. The method according to claim 16, wherein the character encoding format is an American Standard Code for Information Interchange string format.

18. The method according to claim 13, wherein the encoding of the compressed image is configured to change an orientation of the exploit code and the decoder code in the compressed image.

19. A non-transitory, computer-readable storage medium having embodied thereon, computer program instructions executable by at least one processor for proactively preventing a stegosploit attack, the computer program instructions when executed by the at least one processor cause the at least one processor to:
extract a plurality of images from a webpage received from a web server, prior to loading of the images in a web browser on a computing device, wherein each of the images comprises a plurality of pixels, and wherein any one or more of the images is a compromised image comprising an exploit code and a decoder code embedded in the pixels of the compromised image;
generate a replacement image for the compromised image by manipulating the pixels of the compromised image, wherein the manipulation of the pixels of the compromised image deactivates the exploit code and the decoder code of the compromised image; and
embed the replacement image in place of the compromised image in the webpage and deliver the webpage with the replacement image to the web browser on the computing device.

20. The non-transitory, computer-readable storage medium of claim 19, wherein the computer program instructions when executed by the at least one processor cause the at least one processor to generate the replacement image by:
filtering the compromised image by applying a subtraction filtering technique on the compromised image;
compressing the filtered image for deactivating the exploit code and the decoder code of the compromised image by executing a deflate compression algorithm on the filtered image, wherein the deflate compression algorithm is a combination of a Lempel-Ziv compression algorithm and a Huffman coding algorithm; and
encoding the compressed image by executing a Base64 encoding algorithm on the compressed image.
